(19) United States
(12) Patent Application Publication
(10) Pub. No.: US 2014/0278589 A1
(43) Pub. Date: Sep. 18, 2014

(54) MOBILE DEVICE ESTABLISHMENT SYSTEM

(71) Applicant: VERIZON PATENT AND LICENSING INC., Basking Ridge, NJ (US)

(72) Inventors: Steven R. Rados, Danville, CA (US); Sagiv Draznin, Walnut Creek, CA (US); Patricia R. Chang, San Ramon, CA (US); Arda Aksu, Martinez, CA (US); Thomas W. Haynes, San Ramon, CA (US); Deepak Kakadia, Union City, CA (US); Priscilla Lau, Fremont, CA (US); John F. Macias, Antelope, CA (US); Donna L. Polehn, Kirkland, WA (US)

(73) Assignees: Cellco Partnership (d/b/a Verizon Wireless), Arlington, VA (US); Verizon Patent and Licensing Inc., Basking Ridge, NJ (US)

(21) Appl. No.: 13/795,964

(22) Filed: Mar. 12, 2013

(51) Int. Cl. G06Q 30/06

(52) U.S. Cl. CPC G06Q 30/0633
USPC 705/5; 705/26.8; 705/15

(57) ABSTRACT

A method and system and may receive an information request from a user device. An establishment list may be transmitted to the user device in response to the information request, wherein the establishment list includes at least one subscribing establishment. An establishment selection may be received and an establishment option associated with the establishment selection may then be transmitted to the user device. An option selection may then be received from the user device and an establishment record may be updated in response to the selected option, wherein the user device and the subscribing establishments have a pre-existing relationship within the establishment record.

### BACKGROUND INFORMATION

Establishments such as restaurants practice a number of systems to facilitate placing orders and making reservations. For example, traditional paging systems may be used to alert patrons as to when their table is ready. Such paging systems are expensive and may often malfunction or promote the loss of components (e.g., the pagers). Nor are users of such systems aware of the wait time for a table prior to arriving at a restaurant, and online ordering of convenience items such as pizza and coffee may be done using website and mobile applications. However, purchased items may not be ready at an optimal time and may require payment via a credit card, which may be inconvenient to a traveling customer. At times it can even be difficult for a consumer to determine the best store location for a pickup. Thus, a better system for conveniently managing and communicating with an establishment, such as a restaurant, is needed.

### BRIEF DESCRIPTION OF THE DRAWINGS

While the claims are not limited to the illustrated examples, an appreciation of various aspects is best gained through a discussion of various examples thereof. Referring now to the drawings, illustrative examples are shown in detail. Although the drawings represent the various examples, the drawings are not necessarily to scale and certain features may be exaggerated to better illustrate and explain an innovative aspect of an example. Further, the examples described herein are not intended to be exhaustive or otherwise limiting or restricting to the precise form and configuration shown in the drawings and disclosed in the following detailed description. Exemplary illustrations of the present invention are described in detail by referring to the drawings as follows.

FIG. 1 is an exemplary system diagram of the mobile device establishment system;

FIGS. 2A and 2B are an exemplary records for the establishment system;

FIG. 3 is another exemplary system diagram of the establishment system;

FIG. 4 is an exemplary screen shot of a targeted customer service process of the establishment system;

FIG. 4 is an exemplary flow chart of the targeted customer service process;

FIG. 6 is an exemplary screen shot of an establishment customer service process of the establishment system;

FIG. 7 is an exemplary flow chart of the establishment customer service process; and

FIG. 8 is an exemplary work flow process of a convenience service.

### DETAILED DESCRIPTION

Referring now to the discussion that follows and also to the drawings, illustrative approaches to the disclosed apparatuses and methods are shown in detail. Although the drawings represent some possible approaches, the drawings are not necessarily to scale and certain features may be exaggerated, removed, or partially sectioned to better illustrate and explain the disclosed device. Further, the descriptions set forth herein are not intended to be exhaustive or otherwise limit or restrict the claims to the precise forms and configurations shown in the drawings and disclosed in the following detailed description.

Described herein is a mobile device establishment system configured to facilitate communication between a mobile device and a device at an establishment such as a restaurant, retail store, take out location, office, etc. A user, via his or her mobile device, may receive updates as to certain characteristics and features of the establishment. The user may place an order via his or her mobile device and pay an establishment bill directly through a service provider. Additionally, the user may receive notifications from the service provider when a service becomes available, or when the service provider detects a predefined condition wherein the user may be interested in making a purchase at an establishment. These capabilities may provide users and establishments with a convenience service 155 whereby the service provider creates a relationship between subscribing members to easily and efficiently manage and facilitate transactions.

FIG. 1 shows an exemplary system 100 including a first mobile device 105 having a user 110 interface 115 associated with a user 110 and a first communications network 125 configured to facilitate communication between the mobile device 105 and a central office 140. The system 100 may also include a second device 130 associated with a second user 120 or employee of an establishment 145. The second device 130 may be in communication with the central office 140 via a second wireless network 135. The second device 130 may also be referred to as an establishment device 130 herein. Although not shown, an establishment database may be included in the second/establishment device 130. The establishment database may include details and attributes associated with the establishment 145. For example, the establishment database may maintain a list of available tables within a restaurant. It may also maintain a list of resources such as ingredients and other food and beverage items. The list may be continually updated to reflect usage of such resources. For example, if a patron at a restaurant orders lobster and a glass of chardonnay, the list of resources may be updated to show one less lobster and 8 oz. less of chardonnay. Thus, the inventory of the restaurant may be kept in near-real time, allowing restaurant personnel to order and replenish the resources as needed. The establishment database may also maintain a list of available and in-use tables. Each table may include a number of seats available. The database 150 may be capable of tracking an average dining time for each table and thus facilitate server efficiencies, as well as availability of the tables and expected wait-time associated therewith.

The mobile device 105 may include any electronic device, including but not limited to a cellular phone, smart phone, tablet computer, laptop computer, e-reader, personal computer, MP3 device, etc. The mobile device 105 may include a user 110 interface 115 such as a graphical user 110 interface (GUI). The mobile device 105 may be capable of facilitating communications such as voice calls, text messaging, Internet access, etc.

The mobile device 105 may be configured to communicate with a central office 140 via a first communications network 125. The first communications network may include one or more networks, e.g., a telecommunications network maintained by a service provider or one or more public or private data networks. The network 125 may also include a cellular network, Wi-Fi, Bluetooth®, ad-hoc wireless networks, etc. It may also be configured to facilitate communication between the second device 130 and the mobile device 105, and the second device 130 and the central office 140. Thus, the first communications network 125 may permit the exchange of communications between the devices and locations described herein.

The second device 130 may also communication with the central office 140 via the second communications network 135. The second device 130 may include any electronic device, including but not limited to a cellular phone, smart phone, tablet computer, laptop computer, e-reader, personal computer, MP3 device, etc. The second device 130 may include a user interface 115 such as a graphical user interface (GUI). The second device 130 may be capable of facilitating communications such as voice calls, text messaging, internet access, etc. The second device 130 may be associated with an establishment 145 such as a business, including but not limited to a restaurant, take-out establishment, retail store, etc. In one example, the second device 130 may be a tablet computer, such as an iPad associated with a hostess of the establishment 145 and configured to facilitate seating and reservation management.

Similar to the first network 125, the second communications network 135 may also include one or more telecommunication networks. While the second network 135 is shown as a cloud, and the first network 125 is shown as a cellular network via a cellular tower, the two are merely exemplary. Each network may facilitate communication by at least the mechanisms described. Moreover, while the first network 125 and second network 135 are shown as separate and distinct networks, only one network may be used to facilitate communication between the devices 105, 130 and central office 140. Moreover, if the networks 125, 135 are of differing protocols, a gateway may be in communication with both of the networks 125, 135 to facilitate interoperability between the networks 125, 135.

Data may be transmitted between the central office 140 and the second device 130 using any number of wireless standards (e.g., IEEE 802.11, etc.) Data may be transmitted between the central office 140 and the first device 105 using a cellular network. Additionally or alternatively, the central office 140 may include a messaging gateway to facilitate SMS and/or MMS traffic between the devices 105, 130 and the central office 140. Such a gateway may provide gateway-to-mobile services and may be configured to recognize certain short codes supplied by a mobile device. The gateway may also support certain media communications and convert media files received via email. The gateway may permit SMS text messages to be sent and received via email and from web pages or other applications. It may convert messages to the appropriate protocols to be understood by the mobile device 105.

The mobile device 105 may be capable of sending and receiving messages with the central office 140 and second device 130. The messages may include various forms of electronic communication such as electronic messaging (e-mail), text messaging including Short Message Service (SMS) and Multimedia Messaging Service (MMS), voice messaging, etc. In the examples described herein, the mobile device 105 may be described as utilizing text messaging, although this mechanism is exemplary and other types of messages may be implemented to facilitate communication between the devices 105, 130. SMS may allow for 140 bytes per message. SMS may be used by the establishment 145 to send information to the mobile device 105. Additionally, the devices 105, 130 may receive SMS messages from the central office 140. The SMS messages may be sent to a short message service center (SMSC) at the central office 140. This center at the central office 140 may manage incoming messages by storing, converting and delivering them to their intended recipient. MMS messaging may also be used between the devices 105, 130. MMS is an extended version of the SMS, which allows for photographs and videos to be transmitted. An MMS message may be encoded at the sending device before being transmitted. An MMS may be delivered using Hypertext Transfer Protocol (HTTP).

Additionally or alternatively, the first device 105 may be capable of communicating directly with the second device 130 using near field communication (NFC) technologies. NFC may allow for short-range wireless communication between two devices, usually between devices no more than 10 cm apart. The first device 105 and second device 130 may transmit data to each other using an RF field created by the two devices when in close proximity to each other. For example, the first device 105 may transmit a MDN to the second device 130. The second device 130 may in turn transmit other information to the first device 105 such as table availability, menu options, etc., as discussed herein.

The central office 140 may be a service provider's central office and may include a computing device and be configured to provide certain communication services to the user 110 and/or establishment 145. For example, the service provider may provide certain cellular network capabilities to the user 110 of the mobile device 105. Further, the service provider may provide other services such as Internet access, Wi-Fi, cable and on-demand television, land-line telephone etc. The central office 140 may maintain information associated with subscribing users 110/customers within a database 150 (e.g., the first user 110 and establishment 145.) For example, a user record 280, as shown in FIG. 2A, may be included in the database 150. The user record 280 may include specific information and preferences associated with a specific cellular telephone number, or mobile device number (MDN). The user record 280 may be maintained and continually updated at the central office 140. As shown in FIG. 2A, the user record 280 may include a list of services provided to the mobile device 105 by the service provider. It may also include preferred user notifications, such as when a user would like to be alerted to purchase opportunities. For example, a user 110 may wish to be prompted for a coffee purchase upon leaving his or her home. The record 280 may also include preferred orders such as specific items and options associated with those items (e.g., a cheese pizza, or a large black coffee.) Further, preferred locations may also be included in the user record. Each notification, preferred order and preferred location may be represented in the form of a vector. Certain values within the vectors may be associated with corresponding positions of other vectors. For example, the “5:00 PM,” notification may be associated with the “pizza” order and “Hungry Howies™” location. The process of receiving notifications from the central office 140 is described in more detail below with respect to FIG. 5. Billing information may also be included in the user record 280. The billing information may include information about the bill cycle, how the bill is paid (e.g., via credit card, check, etc.), the billing address, convenience system fees, etc.

The database 150 may also maintain information associated with the establishment 145 in an establishment record 290, as shown in FIG. 2B. For example, the establishment 145 may receive certain services from the central office 140 similar to those received by the user device 105. Additional details about the establishment 145 may also be included in the establishment record 290, such as establishment attributes including type of establishment, hours or operation, location, menus, etc. The attributes may also include variable attributes that continually change such as seating and table space, reservation options, inventory, etc. These attributes may be used by the central office 140 to facilitate targeted transactions between an establishment 145 and a mobile device 105, as described below.

Such targeted transactions may be included in a convenience service 155 facilitated by the central office 140. The convenience service 155 may provide a convenient method for paying an establishment for a product or service. This may be facilitated by the central office 140. For example, billing information for each subscriber of the convenience service 155 may be maintained in the database 150. The billing information may include both a fee for the monthly communication services, as well as a monthly convenience charge for using the service. The billing information may also include charges incurred during the use of the service. For example, when a user 110 makes a retail purchase, such as purchasing a coffee, the cost of the coffee may be applied to the user's monthly statement. The establishment 145 supplying the coffee may be paid directly by the service provider, thereby relieving the user 110 of immediate payment. This feature creates service provider bill through, permitting the service provider to take on the burden of the transaction. However, because the transaction is made easier for the establishment 145 and the user 110, more transactions may take place. Further, the service provider may collect a fee from one or both of the user 110 and establishment 145 for subscribing and using the service. On a user's monthly statement, both the cost of the coffee and a service fee may be applied. As mentioned, a monthly fee for subscribing to the service may be included in the user's statement.

Returning to FIG. 1, as explained, the establishment 145 may be any one of a commercial location, personal residence, office, park, etc. For exemplary purposes only, the establishment 145 described herein may be referred to as a restaurant. The establishment 145 may subscribe to the convenience service 155. In addition to providing bill through services, the convenience service 155 may also facilitate organization of certain attributes relating to the restaurant. These attributes may then be applied within an application to produce a recommended action. In one example, the attributes may include seating space within a restaurant. As patrons are seated, the availability of open tables within the restaurant may decrease. Thus, the attribute may be updated to reflect this change. In another example, patrons may continue to order a specific menu item, e.g., a daily special. As the daily special is ordered, the quantity of the item may gradually decline. The menu attribute may be updated. As these attributes are updated, the convenience service 155 may be used by both the establishment 145 and the user/patron 110 to make educated decisions regarding the establishment 145. Using the seating availability attribute, the convenience service 155 may inform the user 110 of the expected wait time for an available table. The user 110 may also be informed that certain menu items are no longer available. With this information, a user 110 may decide whether to wait for an available table and what to order based on availability. These attributes and specific examples are discussed in more detail herein.

The convenience service 155 may be managed by the service provider at the central office 140. The central office 140 may require establishments 145 to subscribe to the convenience service 155. The database 150 may maintain a list of subscribed establishments and may continually be updated by the central office 140 regarding details about the establishments 145 within the respective establishment database (not shown). Moreover, as is discussed herein, the central office 140 may identify these subscribing establishments and provide a list to the user 110.

The convenience service 155 may also be managed within the second device 130. The convenience service 155 may include a convenience application that may be provided by the service provider and downloaded to the device 130 by a user 120 at the establishment 145. Upon subscribing to the convenience service 155, the service provider may charge the establishment 145 a fee, such as a monthly fee, or a use fee. Access to the application may depend on the payment of this fee. If an establishment 145 ceases to pay the fee, access to full functionality of the application may become unavailable. For example, while the application may be stored within the device 130, certain processing may be limited (e.g., determining the number of available tables may not be enabled.) As explained, the processing may be done directly on the device 130 as well as, at the central office 140. Moreover, the central office 140 may provide backup capabilities for the convenience application. The central office 140 may maintain and store specific establishment information, amount of available tables, menus, hours, etc. It may also store temporary data such as the current waiting time for an available table, out-of stock menu items, etc. This temporary data may be updated at a predefined increment, such as every 15 minutes by receiving updated information from the second device. The application may maintain several variable attributes to aid the establishment 145 in running a business. As described above, the attributes may include table availability. The attributes may also include menu item availability or inventory attributes.

In referring to FIG. 3, an exemplary system 100 is shown whereby a user device 105 may be located at a primary location 170, or within a predefined radius 175 of various establishments 145-1, 145-2. The user device 105 and the establishments 145 may be in communication with the central office 140, as described above. A primary location 170 may be the user's home, office, or any other location where the user 110 spends a substantial amount of time. The primary location 170 may be established by the user 110 during enrollment and maintained within the user record 280. The user 110 may, during enrollment of the convenience service 155, establish one or more primary locations 170. The system may also establish one or more primary locations 170 based on a collection of data from the mobile device 105. For example, the central office 140 may maintain a list of the locations of the mobile device 105 over a period of time. This list may be used to generate one or more primary locations 170 of the mobile device 105. For example, the locations with the most re-occurence, may be determined to be a primary residence.

The location of the establishments 145 may be determined based on the second device 130, as described above. Additionally or alternatively, the establishment locations may be included in the establishment records 290. The central office 140 may determine the location of the mobile device 105. This may be done using Global Positioning Systems (GPS). It may also be done using multilateration of radio signals wherein the location of a nearby antenna tower to the mobile device 105 is used to locate the device, i.e. triangulation. Additionally, software within the mobile device 105 may be used to identify the location of the device 105. In this example, the service provider may continuously receive location information from the mobile device 105. In another example, signal strength and mobile device identification may be used to track the location of the mobile device 105. The central office 140 may thus recognize when the mobile device 105 has left a known location, such as the primary location 170.

As shown in FIG. 3, a radius 160 may surround the primary location 170. Upon detecting that a user 110 has left the primary location 170, e.g., moved outside of the periphery defined by radius 160. Upon this detection, a targeted customer service process 500 may be implemented, as described with respect to FIG. 5. A radius 175 may also surround an area having a plurality of establishments 145-1, 145-2. This radius 175 may also act as a trigger when a mobile device 105 enters the area defined by a radius 175 and the central office 140 may send the mobile device 105 a message relating to at least a subset of the establishments 145.

While described in more detail below with respect to FIGS. 4-8, the convenience service 155 may facilitate interaction between an establishment 145-1, 145-2 . . . 145-n and the user 110 via traditional text messaging capabilities, instant messaging protocols associated with an application resident on device 105, social media transmissions, or the like. This interaction may facilitate transactions between the establishment 145 and the user 110 by using location and availability based determinations in combination with user preferences.

In one example, a targeted customer service process 500 may be facilitated by the system. During this process, the central office 140 may provide certain retail options to a user 110 at the mobile device 105 based on the device's location. In another example, an establishment customer service process 400 may also be provided. In this process, the user 110 may use the mobile device 105 to search for establishments subscribing to the convenience service 155.

Additionally, a desired product or service may be located within subscribing establishments 145 based on location and availability. In one example, the desired product may be a coffee. A user 110 may wish to pick up a coffee without having a preference as to the identification of the specific establishment so-long as any other user criteria (e.g., decaf Hazelnut) is met. For example, Breugers^{SM} or Starbucks^{SM} may both be capable of fulfilling the coffee request. Another example may be “pizza.” The central office 140, upon receiving such request, may query the establishment databases to find at least one establishment that currently has inventory matching the request. The query may include establishment specific categories, as described herein. This process is described in more detail with respect to FIG. 5. Samples of communication between the user 110 and the central office 140 using the targeted customer service process 500 are shown in FIG. 6.

An establishment customer service process 400 may also be provided. In this process, the user 110 may use the mobile device 105 to search for establishments subscribing to the convenience service 155. This system 400 may allow users, at any location, to search for subscribing establishments. A search may be based on several attributes, including but not limited to, location inventory, average wait time, type of establishment, hours of operation, etc. Unlike the targeted customer service processes 500, the search may be initiated by the user 110. The user 110 may input a text message at the mobile device 105. The message may include a predefined phrase that is recognizable by the central office 140. One example may be “local restaurants.” Other examples may include “Local take-out” or “five stars.” These phrases may guide the central office 140 to provide more targeted and desired information to the user 110. These requests may be made while the user 110 is not at the establishment 145. The requests may be made while the user 110 is at home, at the office, or traveling. The requests may include an initial phrase, as well as follow up phrases. These follow up phrases may further define desired attributes of the establishments 145 such as “low wait time,” “carry-out,” etc. This process is described in more detail with respect to FIG. 7.

In facilitating the convenience transactions described above, the service provider may incur a fee from the involved parties. In one example, these fees may be applied to the user 110. The user 110 may be charged a flat monthly rate for subscribing to the convenience service 155. Additionally or alternatively, a percentage of the purchase price may be added to the user's bill, (e.g., 5% of the price of the coffee). The establishment 145 may also be charged a fee, either a monthly or percentage based fee. The service provider may also opt to only charge the establishment 145 a monthly fee for the general use of the convenience service 155. This monthly fee may increase as the sales due to the service increase. For example, a lock-step fee schedule may be established such that, for a first amount of purchases through the service, a first fee may be charged. For another increment of purchases, either in quantity or amount, a higher, second fee may be charged, and so on. Thus, for the first 100 purchases, a flat fee may be charged. For the next 100 purchases, a different fee may be charged. The service provider and the establishment 145 may agree on a fee schedule prior to the establishment 145 subscribing to the convenience service 155.

Samples of communication between the user 110 and the central office 140 using the targeted customer service process 500 are shown in FIG. 4. The central office 140 may send a text message, either via SSM or MMS, to the device 105. This message may include an alert or question, such as “Do you want coffee?” The user 110 may return the text by texting “yes” back to the service provider. Upon receiving the affirmative response from the user 110, the central office 140 may alert a subscribing coffee shop as to the user's affirmative response. The central office 140 may already have a user's preferences saved, and thus, be configured to order the coffee from a predetermined coffee shop. The user's exact order may also be saved, either within the database 150, or within the application at the establishment 145. Thus, upon arriving at the coffee shop, the user's beverage may be waiting, saving the user 110 time and providing added convenience. Moreover, the simplicity of ordering a coffee may make users 110 more inclined to make a purchase. Further, if the user 110 is driving, the user 110 may not have the capability to make an online purchase for an item. By providing simple text messaging or the like, it may be easier for the user 110 to send and view messages while the user 110 is traveling, albeit preferably in a non-moving state. Further, the user 110 may be able to use hands-free features of the mobile device 105 to complete the messages to place an order. For example, written communications may be automatically converted into the spoken word (e.g., “Siri” or “Dragon Speak”) or written communications may be bypassed entirely. Additionally, the central office 140 may be capable of paying for the coffee directly. That is, the service provider may directly pay the coffee shop for the coffee and later seek reimbursement from the user 110. In one example, the extra charge for the coffee may be part of a user's monthly service bill from the service provider.

Referring to FIG. 5, an exemplary process is described for the targeted customer service process 500. The targeted customer service process 500 may be initiated in several ways. In one example, the process 500 may begin in response to a trigger such as the mobile device 105 leaving a primary location 170. The process 500 may also be triggered when the mobile device 105 enters a predefined region associated with an establishment (e.g., radius 175.) By detecting a mobile device 105 location, the location may thus trigger a notification from the central office 140. The process 500 may also be user initiated in that a user 110 may request a list of subscribing establishments or may request a certain product be available at an establishment 145. If the process 500 begins based on a change in location of the mobile device 105, the process starts at block 512. If the process is user initiated, the process begins at block 540.

In block 512 the system may determine whether a user 110 has left or entered a region circumscribed by a radius around a recognized location. The location may be a primary location 170, as shown in FIG. 3. As explained, a primary location 170 may be a radius 160 around the user's home, office, or any other location where the user 110 spends a substantial amount of time. The location may be within a radius 175 of an establishment 145 location. The system may detect a change in the mobile device's location by any of the mechanisms described above. The mobile device record 280 within the database 150 may continually be updated with the mobile device location. When the mobile device 105 is recognized to be located at a primary location 170, any movement of the mobile device 105 after that recognition outside of the radius 160 may be flagged to indicate movement away from the primary location 170. Moreover, if the mobile device location is recognized to be within radius 175, the user record 280 may also be flagged.

If the mobile device 105 is determined to have moved with respect to one of the radii 155, 175, the process proceeds to block 514. If not, the process proceeds to START, until such movement is detected.

In block 514, the mobile device 105 may receive a message asking the user 110 if he or she would like to participate in an establishment option or purchase option. An establishment option may include such options like, “Do you want a coffee?” as shown in FIG. 4. Other options may include options to make reservations at a restaurant, ordering a pizza to be picked up, etc. The options presented may be determined by external factors, such as the time of day, the frequency at which a user 110 leaves a primary location 170, etc. These factors may be established by the user 110, may be default factors established by the central office 140, or a combination or both. Referring to FIG. 2A, a user may wish to be prompted and asked if he or she wants coffee when leaving a primary location 170. In another example, the system 100 may be configured to prompt a user 110 based on the time of day. For example, the system 100 may ask the user 110 if he or she wants a coffee in the morning, and ask if the user 110 would like to order a pizza in the afternoon or evening. Moreover, such prompts may be sent based on the day of the week. A prompt for coffee may be displayed Monday through Friday, while a prompt for dinner reservations may only be displayed on Saturday. By targeting the user's potential desires, the likelihood that a user 110 may use the dining option, thus incurring fees for the service provider, increases.

As mentioned, the user 110 may establish these options. This may be done during enrollment of the convenience service 155. Certain preferences may be defined during enrollment, or over time. The preferences may be saved in the user record 280, as described. Certain categories of preferences may be established. In one example, global categories may be established. Global categories may include general user preference. For example, a user may like his coffee black, or he may prefer cheese pizza. Thus, these are general preferences that may be applicable across multiple establishments. In another example, establishment specific preferences may be established. These preferences may apply to only one establishment 145. For example, a user 110 may prefer Starbuck's grande non-fat chi latte.

By maintaining these preferences in the user record 280, the user 110 may not need to specify his or her exact order. The central office 140 may be capable of retrieving his or her special order from the user record/mobile device record 280 associated with that user 110 within the database 150.

In addition to specific prompts for a specific product, more generic prompts may occur. For example, the user 110 may be asked whether he or she would like to stop and eat at a restaurant. For example, the mobile device 105 may receive a message “Would you like to stop and eat?” This may especially be helpful if the mobile device 105 is entering a region circumscribed by a radius that includes several restaurants (e.g., radius 175.)

If the user 110 accepts the proposed option, the process proceeds to block 517. The user may accept a proposed option by responding with a predefined phrase such as “yes” or a “1.” The central office 140 may recognize this phrase. If the option is not accepted, the process ends. In block 517, the central office 140 may identify local establishments capable of fulfilling the request or order. For example, if the user 110 was prompted for a coffee, the central office 140 may query the establishment records 290 for an establishment that can provide coffee (e.g., coffee is listed within the establishment's inventory.) If the user 110 was prompted for a dining option, the central office 140 may query the records 290 for establishments within a predefined radius of the user 110 based on the mobile device location. The user 110 may be provided with a list of potential establishments. For example, as shown in FIG. 6.

In block 518, the user 110 may select an option by entering the numerical digit associated with the option. While the user 110 may select an establishment 145, the establishment 145 may be automatically selected based on the user's predefined preferences within the user record 280 and the location of the mobile device 105. For example, if a user 110 prefers cheese pizza from Hungry Howies, and there is a Hungry Howies within 2 miles of the mobile device location, then Hungry Howies may automatically be selected by the central office 140.

In block 519, the selection is transmitted, via the service provider at the central office 140, to the establishment 145, e.g., the restaurant, coffee shop, etc. The establishment 145 may receive the response via the establishment device 130. The establishment 145 may then review the order (e.g., the request for a small non-fat chi latte coffee) and determine whether they can fill the order, and in what time frame it may be done. In an example where a user 110 has selected an establishment 145 to dine at without requesting a specific item such as coffee or pizza, the establishment 145 may receive review the dining request and determine how busy the establishment 145 currently is with respect to the requested service. For example, a restaurant may be averaging a 15 minute wait time for customers to be seated. Additionally or alternatively, the restaurant may have a long queue of waiting patrons. This information may be based on real-time data and the availability of seating and/or the line length. It may also be based on historical data such as when the restaurant has been busy in the past. For example, although not explicitly shown, the establishment record 290 may include the average wait times based on the day, time, etc. For example, Tuesday afternoons may not have any average wait time, while Friday evenings may have the longest wait time.

In block 520, the central office 140 may receive the establishment's response to the order and in block, 522, may present that response to the user 110. For example, the mobile device 105 may receive a message stating “you order can be ready in 8 minutes.” In the example where an establishment 145 has been selected based on a dining option, the restaurant may return an average wait time to the central office 140. Such a message may explain “there is currently an average of a 15 minute wait to be seated,” or “there are currently 14 people in line.”

In block 524 the user 110 may determine whether the establishment 145 response is acceptable. For example, an eight minute wait may be too long. The user 110 may response with a ‘yes’ message in response, or a ‘no’ message. In responding positively to the dining option, a table may be reserved for the user 110. Although not shown, the user 110 may respond with a number of patrons accompanying him or her, thus an appropriate table may be held for the group.

Additionally or alternatively, if the user 110 does not respond within a predefined period of time, the order may automatically be declined. If the response is acceptable, the process proceeds to block 526. If not, the process ends.

In block 526, the establishment 145 may receive another, second, message via the establishment device 130 indicating that the order or request should be processed. The establishment 145 may process the order/request and have the order waiting/a table reserved for the user 110.

In block 528, the establishment 145 may confirm that the order has been processed and transmit billing information to the central office 140. The order may include a single item order, such as the coffee ordered, or it may include all items purchased by a group dining at the restaurant after their dining experience is over. The billing information may include the date, time, and price of the order. The central office 140, upon receiving the billing information, may in turn charge the appropriate fees to the appropriate parties. For example, the cost of the coffee may be applied to the user's bill. An additional fee may be charged to the establishment 145 for facilitating the transaction. An additional fee may also be included in the user's bill.

In block 530, the system 100 may determine whether the order has been accepted, e.g., picked up by the user 110. If the order has been accepted, the process may proceed to block 532. The establishment 145 may communicate with the central office 140 when the order has been picked up. Additionally or alternatively, the central office 140 may assume that the order has been retrieved upon receiving billing information. Although not shown in FIG. 5, the process may proceed to check whether the order has been retrieved for a predetermined amount of time. A reminder may be sent to the mobile device 105 if the order has not been picked up within a certain amount of time. The reminder may be sent more than once, up to a predefined amount. In one example, if the user 110 has not picked up his coffee within fifteen (15) minutes of his order, the mobile device 105 may receive a reminder message that the coffee is waiting. A reminder may be sent every 5 minutes after that for 20 minutes. After multiple (e.g., four) reminders have been sent, the process may end.

In block 532, the mobile device 105 may receive a message indicating that the purchase price will be applied to the user's bill, as shown in FIG. 4. Although the purchase price may be applied to the user's bill, the user 110 may also choose to pay for the item ordered upon pick up.

In block 540, a user 110 may send a message to the central office 140 via the mobile device 105 indicating the user's interest in a specific item. For example, similar to block 514, the user may wish to purchase a coffee and pick it up while running errands. The user 110 may send a message indicating “I want coffee.” The central office 140 may recognize this phrase. The process may then proceed to block 517 to identify establishments 145 having attributes that align with the request.

Although food and beverages are used throughout to explain the system 100, these are merely exemplary. Other items may also be purchased/requested, such as flowers, groceries, etc. Additionally, other establishments may also take advantage of the system. For example, golf courses may be included in the system to coordinate tee times. Other establishments may also include service providing establishments such as auto garages, car washes, spas and salons, etc.

Samples of communication between the user 110 and the central office 140 using the establishment customer service process 600 are shown in FIG. 6. The establishment customer service process 400 is described in more detail in FIG. 7 and allows a user 110 to find subscribing establishments within a predefined region, such as a radius of the mobile device 105. For example, a user 110, via the mobile device 105, may ask the service provider for a list of local restaurants. This list may be requested by typing in a recognized phrase to the service provider that the central office 140 may recognize. One example may include the phrase “local restaurants?” Another phrase may include “Subscribing restaurants.” The phrase may also include a predefined set of characters creating a shortcut for the request. For example, entering “411” or the local zip code may trigger the system 100 to supply a list of subscribing establishments. The database 150 at the central office 140 may include a list of triggering phrases for each subscribing customer. Thus, upon receiving the triggering phrase, the central office 140 may return a list of subscribing establishments to the mobile device 105, as shown in FIG. 6. The list of subscribing establishments may be maintained in the database 150. The list may include geographical locations for each establishment 145. The geographical location may be used to determine which of the subscribing establishments to transmit to the mobile device 105. For example, the central office 140 may be configured to transmit the five geographically closest establishments. The location of the establishments may be compared with the current location of the mobile device 105. Additionally or alternatively, the central office 140 may return a list including all subscribing establishments within a predefined radius of the mobile device location, e.g., within four miles. Moreover, the central office 140 may query the establishment record 290 and determine how busy each establishment is. In one example, although one restaurant is closer, another, less busy restaurant may be preferred. By maintaining, in the establishment record 290, variable attributes such as how many tables are available, or how long certain lines are, the central office 140 may provide a list of establishments 145 to the user 110 of establishments having a shorter wait time.

The response from the subscribing office may include instructions, in addition to the list, for further utilizing the convenience service 155 such as making a reservation or placing an order. For example, a message may list the subscribing establishments and provide a message indicating that selection of one of the establishments may present additional options. In one example, each listed establishment 145 may be associated with a numerical value, e.g., 1, 2, 3 etc. Upon responding to the message with one of these values, the user 110 may indicate interest in the associated establishment 145. In the example in FIG. 6, the user 110 may return a “1” to indicate interest in Andiamo. The central office 140 may return a message setting forth options with respect to that establishment 145. For example, the message may indicate that the user 110 may make reservations or request a menu.

Similar to selecting an establishment 145 of interest, the user 110 may also select an option by responding with the numerical value associated with that option. In the example, the user 110 responded with a “2,” indicating that he or she wishes to order or see a menu. A menu may be returned by sending a link to a web-based menu. Additionally or alternatively the menu may be received via a pictorial message such as in a .jpeg, .gif or .pct format. The menu may also be received in multiple messages. For example, a first menu page may be transmitted in one pictorial message and a second page may be transmitted in another pictorial message following the first. Essentially the pictorial messages may display the menu to the user, either in total, or in multiple pictorials messages, depending on the size. Each menu item may be associated with an alpha-numerical digit. When ordering, the digit associated with the item may be entered into a text message and returned to the service provider to identify the desired item.

FIG. 7 sets forth an exemplary process for the establishment customer service process 700. The process 700 may be initiated when a user 110 wishes to find an establishment, such as a restaurant, based on certain attributes. These attributes may include location, wait time, menu options, dine-in/dine-out options, etc. The process may begin at block 712. In block 712, the central office 140 may receive a request for establishment information. The request may be made by a mobile device 105 and may be in the form of a message including a phrase from a mobile device 105. As described above with respect to FIG. 6, the phrase may be a text message and include a predefined sequence of characters recognized by the central office 140. Additionally or alternatively, the request may be made via other forms of communication. For example, an email may be received from a mobile device 105. The request may include a request for local restaurants. It may also include and define other attributes, such as wait time, type of establishment, etc.

In block 714, in response to receiving the request for establishment information, the central office 140 may transmit an establishment list to the mobile device 105. As shown in FIG. 6, this list may be transmitted via a text message. The list may include numerical identifiers associated with each establishment 145. The listed establishments 145 may be those that have subscribed to the convenience service 155 with the service provider and that meet the attributes defined by the user's request. Predefined attributes associated with the user preferences may also be included in the user record 280 wherein the user 110 has previously defined certain preferences, such as preferred establishments, etc.

In block 716, the central office 140 may determine whether an establishment 145 selection has been received. As described above, an establishment 145 selection may be made at the mobile device 105 by inputting the numerical identifier of an establishment 145. This numerical identifier may indicate which establishment 145 has been selected so that the central office 140 may provide further information about the selected establishment 145. If the central office 140 receives an establishment 145 selection, the process may proceed to block 718. If not, the process may end.

In block 718, in response to receiving an establishment 145 selection, the central office 140 may present establishment options associated with the selected establishment 145. As shown in FIG. 6, these options may include the option to view a menu or place an order. Other options may also be included such as options to view establishment information, such as the establishment hours, address, phone number, etc. Similar to the list of subscribing establishments provided, each establishment option may also be associated with a numerical identifier. A user 110 may respond, via a text message, with a numerical identifier associated with the establishment 145 option of interest to the user 110. Although not shown in FIG. 6, the establishment 145 options may also include a default character designated to clear prior selections.

In block 720, the central office 140 determines whether an establishment 145 option has been selected. If an option has been selected via an input of a numerical character associated with that option, the process may proceed according to that selection. If no option was selected, the process may proceed to block 714, where another list of subscribing establishments may be presented. This second list may differ from the original list in the event that the user's location has changed. In one example, the user 110 may be traveling in a vehicle and thus, the location of the user 110 relative to subscribing establishments may change.

In block 721, the central office 140 may determine whether the received selection includes a dine-in selection for the establishment 145. The establishment record 290 may include this attribute and upon selecting the dine-in option, the process may proceed to block 722. If not, the process may proceed to block 736.

In block 722, the central office 140 may determine whether an option to make a reservation may have been selected. The process may proceed to block 726 and the central office 140 may present reservation options. The reservations options may be presented via text message and may include a list of available times e.g., an establishment's operating hours. If a reservation option has not been selected, the process may proceed to block 736.

In block 728, the central office 140 may receive information including a reservation request from the mobile device 105. The request may include a desired time for a reservation, as well as a number of patrons. This request may be received via text message and may include a message such as “7:00 PM, 5 people.” The central office 140 may be capable of recognizing this format, as well as variations of this format. Once the central office 140 has received a reservation request, the process proceeds to block 730.

In block 730, the central office 140 may compare the reservation request with the indicated availability of the establishment 145. Via the establishment device 130, the establishment 145 may be continually transmitting availability information to the central office 140. This availability information may be stored in the establishment database and may include resource or information such as table availability and menu item availability. Based on the availability information associated with the establishment 145, the central office 140 may determine whether the reservation request may be granted. In one example, the restaurant may not have capacity for 5 patrons at 7:00. If the restaurant does not have capacity to accept the reservation, the process proceeds to block 734. If the restaurant does have the capacity, the process proceeds to block 732.

In block 732, the reservation request may be confirmed to the mobile device 105 via a confirmation message. Such message may include “Reservation confirmed.” If a request is confirmed, the establishment database may be updated to reflect this reservation. The process may then end.

In block 734, the reservation request may be denied and a message may include “Reservation unavailable, please select new time.” The process may then proceed to block 726.

In block 736, the menu may be presented. If the user 110 has selected a dine-out option of an establishment, the user may wish to view that establishment's menu. As explained above, the menu may be transmitted to the mobile device 105 from the central office 140 by presenting a link to a menu. The link may be a link to a file, or may be a link to a web page or web site including the menu. The menu may also be transmitted as a media file such as a photo, video, etc. The menu may include items available for purchase such as food entrées, take-out items, convenience items, etc. Each item may include an identifier associated therewith. In one example, a medium pizza may be associated with a ‘1’, while a large pizza may be associated with a ‘2.’ Specific toppings of the pizza may also be associated with certain identifiers. Pepperoni may be associated with a ‘P’, while mushroom an ‘M’ and extra cheese ‘C’. Additionally or alternatively, the user 110 may be taken to a web-based menu capable of taking online orders. The customer may review the menu and decide whether to make an order. If so, the process may proceed to block 738.

In block 738, the central office 140 may receive information indicating an order selection from the mobile device 105. The order may include single, or multiple items. A string of characters separated by an operator may represent a user's order. For example, if a user 110 wishes to order a cheeseburger associated with the indicator ‘55’, a vanilla milkshake associated with ‘MS’, and fries associated with ‘FF’, the order may be included in an exemplary message “55, MS, FF.” The central office 140 may use these indicators and match them against the menu to fulfill the customer's order. The establishment record 290 at the central office 140 may be updated with the order information. Alternatively, the message may be directly forwarded to the establishment 145 and the establishment 145 may fulfill the order based on the identifiers. The process may then end.

FIG. 8 shows an exemplary flow chart for an establishment work flow process 800. The establishment workflow process 800 may include coordinating seating availability with order prep time. For example, if a group of patrons are waiting to be seated, the group may submit their order while waiting to be seated. The process 800 may coordinate the time of a table becoming available with the preparation of their order so that upon arriving to their table, at least a portion of their order is ready. In one example, as the patrons are seated, their drinks may be arriving at the table.

The process may begin at block 812. At block 812 a patron or group of patrons may arrive at an establishment 145 such as a restaurant. The patrons may request a table. The request may be made to a hostess or may be made using the mobile device 105, as explained above with respect to block 722.

At block 814, the patrons may also supply a mobile device number (MDN) to the hostess, or the establishment device 130. The MDN and requested seating or reservation may be inputted via the establishment device 130. Additionally or alternatively, the first device 105 may transmit the MDN to the second device 130 via NFC. The establishment device 130 may maintain in the establishment database a list of available tables, available resources, etc. The central office database 150 may also maintain this information. Additionally or alternatively, the central office 140 may receive updates from information stored within the establishment database at predefined increments. Thus, when a mobile device 105 associated with a user 110 is not currently present at the establishment to request reservations, the central office 140 may use the most recently updated data from the establishment device 130 to process the request.

In block 818, based on the requested seating, a wait time may be established and presented to the patrons. The wait time may be established based on the a number of factors and attributes including but not limited to, the number of tables available for the requested party size, the time at which other patrons were seated at the tables, the average dining time of a party of that size, etc. The patrons may receive this wait time from the hostess, or the wait time may be transmitted to the mobile device 105. This mobile device 105 may then display, via a text message, the expected wait time.

In block 820, a menu may be displayed via the mobile device 105. The menu may be displayed in many forms, as described above.

In block 822, after reviewing the menu, the patrons may place their order via the mobile device 105. The order may be placed as described above with respect to block 738. The order may include drinks for each patron, appetizers, entrées, deserts, etc. Upon receiving the order, the process proceeds to block 824.

In block 824, the establishment device 130 or the central office 140 may determine an order time, i.e., the time that it may take to prepare the order. This determination may take into account various factors such as complexity of the items ordered, number of items ordered, number of patrons ordering items, etc. Moreover, the timing may include a timing subset for each course. For example, a separate order time may be established for each meal course (e.g., drinks, salads, entrées, deserts, etc.)

In block 826, the expected order time and subset order time may be coordinated with the expected seating time so that at least a portion of the patrons' order is ready upon seating. For example, the patrons' drinks may be waiting for them as they as seated. Shortly after the patrons are seated, the first course may be brought to the table. In another example, the main course may be coordinated to be ready approximately 30 minutes after the patrons have been seated. The coordination may be done by the establishment device 130 or by the central office 140. Moreover, the coordination may indicate to the effected establishment personal how and when certain events should take place. For example, if a party is to be seated at 7:15 PM, a bartender at the restaurant may receive a message on another establishment device at 7:00 PM to start preparing the drink order for that party. Moreover, the chef and associated personnel may also be prompted to begin preparing the entrées at this time to ensure that the entrées are ready around 7:45. By coordinating the estimate seating time with other establishment 145 operations, the dining experience of the patrons may be of higher quality. Moreover, restaurant resources may be optimized.

The establishment device 130 may include a plurality of establishment devices 130. Multiple devices 130 may be used to coordinate resources using establishment heuristics. For example, the hostess, the chef and the server within a restaurant may have access to an establishment device 130. The chef may receive an indication to begin cooking a selected dish based on the expected prep time for the dish and the expected seating time. Moreover, a general alert may be transmitted to all employees once a party has been seated. This may indicate to the server to bring the party's drink order or to approach the table to assist the party with their dining experience (e.g., collect orders, go over specials, etc.) Thus, a fully integrated convenience service 155 may result in the use of multiple devices 130 within an establishment 145. The information used to coordinate these devices may be stored in a cloud location, within an establishment database, within one of the devices 130, or within the database 150 at the central office 140.

The establishment device(s) 130 may also be used to maintain inventory accounts. For example, the establishment database may maintain a list of resources such as ingredients and other food and beverage items. The list may be continually updated to reflect usage of such resources. For example, if a patron at a restaurant orders lobster and a glass of chardonnay, the list of resources may be updated to show one less lobster and 8 oz. less of chardonnay. Thus, the inventory of the restaurant may be kept in near-real time, allowing restaurant personnel to order and replenish the resources as needed. Additionally or alternatively, NFC may be used by the establishment devices 130 to catalog the usage of certain inventory. For example, certain inventory, such as wine, meats, deserts, etc., may be associated with an NFC tag. These tags may be powered by a device when that device reads the tag. That is, the RF field of the second device 130 may temporarily provide enough power to the NFC tag to allow the tag to transmit data to the second device. In one example, a chef may retrieve an item from a refrigerator within the kitchen. This item may be a high demand item such as lobster. The lobster may be stored within a certain compartment associated with the NFC tag. Upon retrieving the lobster, the chef may use the second device 130 to ‘scan’ or connect with the associated NFC tag on the compartment. The tag may transmit data indicating that the lobster compartment has been accessed, or indicating that a lobster has been removed. The establishment database may be updated to reflect this and thereby maintain a near-real time account of an establishment's inventory.

In addition, NFC readers or tags may be positioned at various locations within the establishment to permit better estimation of timing considerations. For example, NFC readers at the entrance, host station, and bar may interact with NFC tags of the mobile device to indicate where a party is located at a particular time. This information may be used to provide appropriate notifications to the mobile device, such as suggesting drink specials if the subscriber has checked into the bar area.

In block 828, a message may be transmitted to the mobile device 105 when the table for the patrons associated with the mobile device 105 is ready. Thus, if the patrons are not within the restaurant, the patrons may return and take their seats. This prevents patrons from having to wait at the restaurant while a table becomes available. Moreover, it may prevent the establishment 145 from dispensing devices to the patrons while they wait, reducing overhead costs for the establishment 145.

In block 830, upon completion of the dining experience, the patrons may pay the establishment bill by authorizing the establishment 145 to charge them through the service provider. The bill may be paid through the service provider using the patrons' account as described above. Because there the user/patrons 110 and the establishment 145 both subscribe to the convenience service 155, the convenience service 155 may facilitate the transaction through the central office 140. Accordingly, the charges presented in the bill may be passed through to the patrons' monthly service bill. As described above, the service provider may add additional charges to the bill at either the establishment end or the user end. The establishment 145 and/or user 110 may pay a flat monthly fee for the convenience service 155. Additionally or alternatively, a percentage based fee schedule may be applied. Payment may be authorized using the mobile device 105. The amount to be paid may be transmitted to the mobile device. The user 110 may be prompted to pay the bill, e.g., “Would you like to pay the above amount via service provider bill through?” The user 110 may accept this by responding “yes.”

The systems and methods described herein provide for a trusted relationship between users and establishments using the service provider. The service provider may facilitate transactions by allowing automated prompts, advanced reservations, inventory heuristics, and automatic bill pay, among others, to be automated between the multiple devices at multiple locations. Other advantages may also be implemented. In one example, users subscribing to the convenience service 155 may have priority over those who do not. For example, a certain amount of tables at an establishment 145 may be designated for subscribing customers only. Thus, subscribing users may be favored when making reservations over non-subscribing customers. Further, additional promotions may be directed directly to the mobile device 105 from the central office 140 via text messaging. By using text messaging to facilitate transaction, the security of the transaction is increased over other methods, such as using mobile applications. Further, no credit card information is required to make a purchase using the convenience service 155, further increasing the security of the transaction. The heuristics and databases allow for a functional, convenient and customizable system.

In general, computing systems and/or devices, such as the mobile device 105 and second device 130, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein, may include various kinds of mechanisms for storing, accessing, and retrieving various kinds of data, including a hierarchical database 150, a set of files in a file system, an application database 150 in a proprietary format, a relational database 150 management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed as new and desired to be protected by Letters Patent of the United States is:

1. A method comprising:
identifying at least one subscribing establishment based on attributes associated with the at least one establishment;
transmitting an identification of the at least one subscribing establishment to a mobile device;
receiving a selection of the at least one subscribing establishment from the mobile device;
transmitting at least one establishment option associated with the at least one subscribing establishment to the mobile device in response to the selection; and
transmitting, to the at least one subscribing establishment, a response to the at least one establishment option from the mobile device.

2. The method of claim 1, further comprising receiving a request for at least one establishment from the mobile device before identifying the at least one subscribing establishment.

3. The method of claim 2, wherein the request identifies at least one preference and wherein the at least one preference is used to identify the at least one subscribing establishment based on attributes associated with the at least one subscribing establishment.

4. The method of claim 3, wherein the at least one preference is maintained in a user record and is associated with the mobile device.

5. The method of claim 1, further comprising instructing the at least one subscribing establishment to fulfill the selected at least one establishment option.

6. The method of claim 5, wherein the selected at least one establishment option includes at least one of making a purchase or making a reservation.

7. The method of claim 6, further comprising detecting a location of the mobile device within a predefined region before identifying the at least one subscribing establishment.

8. A system comprising:
a computing device configured to:
transmit to a user device an establishment list in response to a request from the user device, wherein the establishment list includes at least one subscribing establishment;
receive an establishment selection associated with and in response to transmitting the establishment list from the user device;
transmit establishment options associated with and in response to receiving the establishment selection to the user device;
receive an option selection among the establishment options from the user device; and
update an establishment record in response to receiving the selected option.

9. The system of claim 8, wherein the establishment record includes a plurality of establishment attributes associated with the at least one subscribing establishment.

10. The system of claim 9, wherein the establishment options include at least one of making a reservation at the selected establishment, placing an order with the selected establishment, or reviewing a menu associated with the selected establishment.

11. The system of claim 8, wherein the option selection includes reviewing a menu associated with the selected establishment and wherein the computing device is further configured to transmit a menu to the user device.

12. The system of claim 10, wherein the option selection includes a request for a reservation at the at least one subscribing establishment.

13. The system of claim 12, wherein the computing device is configured to compare the request for a reservation with attributes associated with the at least one subscribing establishment and update the establishment record in response to accepting the request for a reservation.

14. A non-transitory computer readable medium tangibly embodying computer-executable instructions, comprising:
detecting that a mobile device has crossed a geographic threshold;
transmitting a targeted message to the mobile device in response to the geographic threshold being crossed, the targeted message including at least one option related to at least one subscribing establishment related to the geographic threshold;
transmitting a request to an establishment of the at least one subscribing establishment based on a received response to the targeted message;
receiving an indication that the request has been fulfilled by the establishment; and
generating a fee based on the fulfilled request.

15. The medium of claim 14, wherein the targeted message includes at least one of a Short Message Service (SMS) and Multimedia Messaging Service (MMS) message to the mobile device.

16. The medium of claim 14, further comprising applying the fee to at least one of a user record related to the mobile device and an establishment record related to the establishment.

17. The medium of claim 14, wherein the request includes a request for a retail transaction.

18. The medium of claim 14, wherein the targeted message is generated based on preferences defined within a user record related to the mobile device.

19. The medium of claim 18, wherein the preferences include at least one of a time of day and location.

20. The medium of claim 14, wherein the preferences include at least one of an item associated with a specific subscribing location.
